(19) United States
(12) Patent Application Publication
(10) Pub. No.: US 2008/0089208 A1
(43) Pub. Date: Apr. 17, 2008

(54) Near Field Lens-To-Carrier Approach

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,704

(22) PCT Filed: Sep. 30, 2005
(86) PCT No.: PCT/IB05/53225

§ 371 Date: Apr. 5, 2007

(30) Foreign Application Priority Data
Oct. 11, 2004 (EP) 04104966.9

(51) Int. Cl. G11B 7/135; G11B 7/085; G11B 7/09

(52) U.S. Cl. 369/112.23

(57) ABSTRACT

The present invention provides a near field optical scanning device and in particular a method of bringing a lens (24) of a near field optical scanning device from a remote position to a near field position (23) relative to the surface of a record carrier (11). The invention makes preferably use of image processing of aperture pupil images indicating the size of a gap between a Solid Immersion Lens (SIL) and the surface of the record carrier. Image analysis of the aperture pupil image allows to derive a control signal for an approach procedure for air gap distances in a range of micrometers. This allows for a fast, efficient, accurate and reliable approach procedure making use of varying velocities of a head movement. Moreover the invention allows to make use of a detection scheme for interference fringes evolving in the aperture pupil image that principally allow to alternatively generate a control signal for the approach procedure and to reduce image analysis to an analysis of the intensity of the a section of the aperture pupil image.

### FIELD OF THE INVENTION

The present invention relates to the field of optical scanning devices for scanning record carriers, and in particular without limitation to scanning record carriers making use of evanescent coupling of radiation.

### BACKGROUND OF THE INVENTION

Near field recording and readout making use of a Solid Immersion Lens (SIL) provides high density optical recording and reading, in particular by making use of record carriers, such as optical discs, having e.g. 12 cm in diameter. In order to realize sufficiently small scanning spots of the optical radiation onto the information layer of the record carrier, evanescent coupling of the radiation beam from the SIL to the record carrier is desired. Evanescent coupling effectively occurs at distances between the SIL and the surface of the record carrier that are below a fraction of the applied optical wavelength. Hence, the gap size between the SIL and the record carrier typically has to be in a range of e.g. 25 nm to 50 nm. Such systems are known as near field systems, deriving their name from the near field formed by the evanescent wave at an exit face of the SIL. An exemplary optical scanning device may use a radiation source which is a blue laser and emits a radiation beam that has a wavelength of approximately 405 nm.

During scanning of the record carrier, hence during recording or reading of information, the evanescent coupling between the exit face of the SIL and the surface of the record carrier has to be maintained. The efficiency of this evanescent coupling strongly depends on the gap size between the SIL and the surface of the record carrier. If the gap size increases and becomes sufficiently larger than e.g. 50 nm, the coupling efficiency may remarkably decrease leading to a decrease in the quality of the data being read, possibly with the introduction of errors into the data signal.

Prior to performing a scanning procedure of a record carrier, it is common for optical scanning devices to perform a start-up procedure. Such a start-up procedure ensures that components of the optical scanning device are correctly positioned so that the scanning procedure, for example reading data from or writing data to the record carrier, may be performed at a high level of quality.

A start-up procedure may involve moving an objective system of the scanning device from a standby position to a scanning position. This can include a combination of an approach procedure using an open loop operation and a pull-in procedure using a closed loop operation and ensures that the size of the gap between the objective system and the record carrier is optimized for the scanning procedure. The objective system, and in particular the SIL is in the standby position, when for example, no record carrier for scanning is arranged within the optical scanning device, or the power to the record carrier is switched off or is set to a standby mode, or an opening of the scanning device, through which a record carrier may be inserted within the scanning device, is open. Moreover, in this standby position, the objective system may be arranged so that delicate optical components of the objective system are protected from impacts, scratches and other contaminations, like e.g. dust.

Near field optical systems are known as such from K. Saito, et al. “Readout Method for Read Only Memory Signal and Air Gap Control Signal in a Near Field Optical Disc System,” Jpn. J. Appl. Phys. Vol. 41 (2002), pp. 1898-1902. This document discloses an optical near field scanning device and a method of obtaining an optical air gap control signal for near field optical disc systems. This air gap control signal allows to control a servo system that adjusts the gap size and may be used in a pull-in procedure for moving the objective system by the servo system to an optimum position for the scanning procedure. Typically, the air gap control signal can be obtained by using a difference between the polarization states of reflected and incident light. This difference in the polarization states occurs when the SIL is close to the disc surface, i.e. when the air gap features a size for which evanescent coupling starts to occur. Hence, the air gap control signal is only indicative and is only available for distances between the SIL and the disc surface that are smaller than 50 nm.

However, in a standby position, the air gap between the objective system and the record carrier may feature several or even hundreds of micrometers. Since the air gap control signal is only available for distances in the range of a small fraction of a micrometer, during a startup procedure, the objective system and the SIL have to approach the record carrier with a sufficiently small velocity for not being moved beyond the optimum position and for not colliding with the record carrier. Such a collision may result in damage, or failure of, either the objective system or the record carrier.

### SUMMARY OF THE INVENTION

The present invention therefore aims to provide an optical scanning device providing an air gap control signal being available for fairly large air gaps and thus allowing to perform an approach procedure in a fast and efficient way.

The present invention provides a near field optical scanning device for scanning a record carrier using evanescent coupling by accurately and efficiently positioning an objective system with respect to the record carrier. The inventive optical scanning device comprises a head having an objective system and in particular having a SIL that is adapted to be positioned in a near field position relative to the surface of the record carrier. The device further comprises a detector that has a spatial resolution for detecting radiation entering the optical head via the SIL and the objective system of the head. Further, the near field optical scanning device comprises an image processing module for analyzing the detector output and for generating a control signal being indicative of the distance between the lens, in particular the SIL, and the record carrier. The control signal serves as an air gap control signal and is generated by means of image processing of an image acquired by the near field optical scanning device. Additionally, the near field optical scanning device comprises a control module for controlling the gap size of the gap between the lens and the surface of the record carrier. This control module is operable in an approach mode for moving the lens from a remote position to the near field position by making use of the control signal generated by means of the image processing.

Preferably, the objective system of the head of the near field optical scanning device projects a transverse radiation distribution onto the detector that generates an output signal that is processible by the image processing module. Typically, the detector output is indicative of a two dimensional or one dimensional transverse light distribution representing e.g. an aperture pupil image of the objective system or a cross section thereof.

The image of the aperture pupil typically varies with a changing distance between objective system and record carrier surface. Advantageously, the transverse spatial structure of radiation entering the optical head, i.e. radiation being reflected by the record carrier features detectable modifications for gap sizes of up to 100 or more micrometers. Changes in the transverse light distribution of the pupil image become more and more prominent as the gap between the objective system and the surface of the record carrier is reduced.

Since the transverse spatial structure of the radiation entering the head becomes more prominent with decreasing gap size, the control signal can be generated with increasing accuracy towards smaller distances. This allows to realize a fast and efficient approach mechanism featuring high accuracy for effectively preventing collisions between objective system and record carrier.

Moreover, since the transverse light distribution pattern of the detected radiation is indicative of gap sizes in the range of several tens of micrometers, the control signal generated by means of the image processing module is correspondingly indicative of gap sizes in the micrometer range. Consequently, the control module exploiting the control signal may perform an approach procedure for the objective system in a faster and more efficient way.

In a preferred embodiment, the control module of the near field optical scanning device is operable to move the lens from the remote position to the near field position with varying velocity. Preferably, the initial velocity and the way of varying the velocity depends on the control signal generated by means of the image processing module.

According to a further preferred embodiment of the invention, the control module is further operable to move the lens by making use of a decreasing velocity profile starting with a maximum velocity. Also here, maximum velocity and velocity profile may be determined in response of receiving the control signal from the image processing module being indicative of the actual gap size between SIL and record carrier surface. If the control signal represents a rather large gap size, e.g. in the range of 10 to 20 micrometers or even larger, the control module may move the objective system and/or the SIL with a maximum speed towards the surface of the record carrier and may decrease the velocity when the gap size is around e.g. 1 micrometer.

The gap size for which the velocity has to be reduced depends on the accuracy of the generated control signal. Accuracy information of the control signal may be obtained by a calibration procedure. The decrease of the velocity during an approach procedure may be performed in different ways. For example, a velocity decrease may be performed step wise or in a continuous mode, either in a linear or non-linear way. Preferably, a decreasing velocity profile can be described by means of an exponential function featuring a negative argument, such as exp(−C/t) where C is a constant and t denotes time.

According to a further preferred embodiment of the invention, an at least second control signal is generable during a movement of the lens and wherein the control module is further operable to process the at least second control signal during the movement. The at least second control signal represents continuous generation of control signals during an approach procedure. In this way the movement of the objective system and the SIL can be sufficiently controlled while the SIL is moved from the remote position to the desired near field position. This allows for effectively controlling and adjusting the approach procedure and effectively provides a control mechanism for preventing collisions between SIL and record carrier.

According to a further preferred embodiment of the invention, the image processing module is adapted to determine the size of a central section of the radiation in a transverse plane of the radiation. The size or diameter of the central section corresponds to a gap size that is substantially larger than the gap size for which evanescent coupling between the lens and the record carrier effectively occurs. This size of the central section of the transverse light distribution detected by means of the detector is used by the image processing module for generating the control signal. The image processing module is therefore adapted to determine the size or diameter of a distinct light distribution pattern of the detected radiation.

This distinct light distribution pattern typically corresponds to a bright spot or bright circular shaped area in the center of a two dimensional representation of a detected transverse light distribution. Typically, the transverse light distribution of radiation entering the objective system provides an image of an aperture pupil featuring an outer bright ring and an inner circular shaped region with a lower intensity. For large air gap sizes between objective system and record carrier, the inner region features a rather homogeneous low intensity and appears as a rather dark circular shaped region having a bright central spot indicating the gap size.

The outer bright ring of the aperture pupil image is effectively due to total internal reflection of light rays at the exit surface of the SIL. These light rays being subject to total internal reflection propagate at an angle exceeding the critical angle for total internal reflection. Due to this large propagation angle, this totally reflected light appears as outer bright ring of the aperture pupil image. The inner, rather dark, circular shaped region of the central aperture pupil image is due to transmission of light beams through the SIL towards the record carrier. These transmitted light beams propagate at an angle below the critical angle of total internal reflection. Due to the optical arrangement of the objective system, the boundary between the inner and outer circular shaped regions in the aperture pupil image is governed by the angle of total internal reflection of the SIL, i.e. the numerical aperture (NA)=1. The outer boundary of the bright, outer ring shaped region is governed by the angle of the marginal rays, i.e. the numerical aperture of the objective system, e.g. NA=1.9.

For near field optical scanning, the focal spot of the objective system almost coincides with the lower surface, i.e. the exit surface, of the SIL. The aperture pupil image is acquired on the basis of light being reflected at the SIL's exit surface by maintaining the angle of incidence. Also, a bright central section typically appears in the aperture pupil image. This, typically circularly shaped, bright central section of the aperture pupil image is due to light being reflected at the record carrier. The size and the transverse diameter of this central section remarkably increases as the gap between SIL and record carrier surface decreases. Advantageously, the bright central spot or bright central section of the aperture pupil image can be clearly detected at distances and gap sizes of several tens of micrometers.

The image processing module is adapted to identify the bright central section of the aperture pupil image by making use of image processing means including brightness and contrast modification means that allow for an accurate and reliable determination of the size of the bright central section. Determination of the size of the central section can be based on a two dimensional image processing or on a one dimensional image processing provided that a one dimensional stripe detector intersects with the bright central section of the aperture pupil image. Hence, the detector of the near field optical scanning device can be implemented as a one dimensional or two dimensional detector array, such as a one or two dimensional charge coupled device (CCD).

According to a further preferred embodiment of the invention, the image processing module is further adapted to analyze the spatial structure of the central section of the radiation in a transverse plane of the radiation. The spatial structure of the central section can be further used by the image processing module for generating the control signal indicating the gap size between the SIL or objective system and the surface of the record carrier. Since the objective system of the near field optical scanning device also provides radiation that is transmitted towards the record carrier, the central section of an aperture pupil image may feature an intensity modulation that is due to e.g. interference between incident and reflected light.

In particular, the number of interference fringes in the spatial structure of the bright central section of the aperture pupil image is also indicative of the gap size. In this way, not only by determining the transverse diameter, but also by analyzing the spatial structure of a bright central section in the aperture pupil image, a gap size in the range of several micrometers can be accurately measured and continuously monitored.

According to a further preferred embodiment, the image processing module is adapted to monitor the intensity of the central section of the radiation in a transverse plane and to generate the control signal in response of the intensity exceeding a predefined threshold. Monitoring of the intensity of the central section of the entering radiation may serve as an alternative means for determining the size of the central section. Monitoring and measuring of the intensity may also be performed on the basis of a predefined section in the transverse plane of the entering radiation. For example the intensity might be detected not over the entire inner circular shaped region of the aperture pupil image but only at a particular position within the aperture pupil image featuring an arbitrary size. Moreover, by monitoring the intensity, a spatial resolution of the detector is generally not required. In this way the detector of the near field optical scanning device might be implemented as a conventional photodiode. Making use of such an embodiment also allows to reduce the complexity of the image processing. Hence, the intensity being detected by means of a photodiode can directly serve as a control signal that has to be processed by the control unit.

Preferably, the intensity of the central section of the radiation is monitored during a displacement of the lens towards the near field position. Typically, the intensity of the central section of the aperture pupil image remains substantially constant for gap sizes in a range above 10 micrometers. As soon as the transverse diameter of the central section of the aperture pupil image increases interference fringes typically evolve in the central section. If only a small section of the aperture pupil image is acquired, an oscillation of the total acquired intensity during a continuous displacement of the lens may be observed. This intensity modulation, that is typically accompanied with an increasing total intensity signal of the central section can be effectively used for generating a control signal being indicative of gap sizes in a range of approximately 50 nm up to 5 or even more micrometers.

According to a further preferred embodiment of the invention, the central section of the radiation in the transverse plane of the radiation substantially corresponds to radiation re-entering the lens and the objective system. This re-entering is typically due to reflection at the surface of the record carrier after being transmitted through the lens towards the record carrier. Since the focal spot of the objective system almost coincides with the lower surface or exit face of the SIL, for large gap sizes, radiation being transmitted through the lens towards the record carrier strongly diverges and impinges the surface of the record carrier over a rather large transverse region. Consequently, due to reflection at the planar surface of the record carrier, only a very small fraction of transmitted light re-enters the objective system. For large gap sizes, only radiation propagating at rather small angles of incidence with respect to the optical axis of the objective system re-enters the objective system and may be represented as bright central section of the aperture pupil image.

For smaller gap sizes the circumference of transmitted light on the surface of the record carrier decreases and a larger portion of reflected light may re-enter the objective system at larger angles of incidence leading to a larger diameter of the bright central section of the radiation entering the objective system.

According to a further preferred embodiment of the invention, the control module is adapted to switch into a gap control mode if the lens has been moved to the near field position. The control module is therefore operable in an approach and a gap control mode. Preferably, in the gap control mode, a control signal is generated on the basis of comparing polarization states between reflected and incident light. Since this required change in the polarization state effectively occurs when the SIL is in the near field distance with respect to the surface of the record carrier, the control module is operable in the gap control mode during scanning of the record carrier, i.e. when the objective system and/or the SIL is in a near field position, which means that the gap is small enough to provide efficient evanescent coupling of optical radiation between the record carrier and the objective system.

In another aspect, the invention provides a method of bringing a lens of an optical head of a near field optical scanning device from a remote position to a near field position relative to the surface of a record carrier. The inventive method comprises detecting radiation that enters the optical head by making use of a detector that has a spatial resolution. The method further comprises analyzing the detector output by making use of an image processing module for generating a control signal that is indicative of the distance between the lens and the record carrier.

The method further comprises moving the lens from the remote position to the near field position by making use of the control signal. The control signal is preferably generated by identifying the size and/or diameter of a circular shaped central bright section of a one dimensional or two dimensional spatial light distribution entering the head or its objective system. Since the bright central section already evolves for large gap distances, e.g. in the range of several micrometers, the control signal is already available for these rather large gap sizes allowing to perform a fast, efficient, precise and reliable approach scheme for the objective system and its SIL.

In a further preferred embodiment the method comprises moving the lens with a predefined velocity towards the record carrier prior to generation of the control signal and monitoring the size of a central section of the radiation in a transverse plane of the radiation by means of the detector and the image processing module during moving of the lens with the predefined velocity. The method further comprises generating the control signal by making use of the monitored size of the central section of the radiation. For example, the control signal may be generated when the size of the central section exceeds a predefined threshold value, thereby indicating that the gap size between SIL and record carrier surface drops below some predefined value.

In another aspect the invention provides a method of bringing a lens of an optical head of a near field optical scanning device from a remote position to a near field position relative to the surface of a record carrier. This method comprises moving the lens from the remote position towards the record carrier, preferably by making use of a predefined velocity and monitoring the intensity of a radiation entering the optical head during moving of the lens by making use of a detector. Further, a control signal is generated that is indicative of a distance between the lens and the surface of the record carrier.

This control signal is generated in response of detecting at least one oscillation of the intensity of the radiation with respect to the movement of the lens. Additionally, the lens or the objective system of the head is moved to the near field position by making use of the control signal. This method particularly allows to make use of detectors that do not feature a spatial resolution, like photodiodes. Here, the detector only has to detect the intensity of an incoming radiation. Monitoring the intensity of the incoming radiation may refer to the total intensity or to an intensity of a predefined spot or section within the transverse plane of the incoming radiation.

An oscillation of the monitored intensity with respect to the movement of the lens preferably evolves due to interference between counter propagating light rays, i.e. light that is transmitted through the SIL towards the record carrier and light that is reflected from the record carrier towards the aperture of the objective system. Successive maxima or minima of the oscillation of the intensity correspond to a movement of the lens of half the wavelength of the applied radiation. In this way also by counting maxima and/or minima of these oscillations while moving the lens towards the record carrier, the gap size can be determined at least within a range of multiplies of λ/2 of the radiation, with an accuracy below λ/2.

Hence, oscillations of the intensity refer to gap sizes in the range of several multiplies of half of the wavelength of the radiation whereas evanescent coupling effectively occurs for gap sizes in the range of a small fraction of the wavelength applied with the near field optical scanning device. Consequently, by monitoring the intensity of the central bright section of the aperture pupil image, a control signal can be generated being indicative of gap sizes of up several micrometers. Making use of such a control signal, an approach procedure of moving the an SIL from a remote position to a near field position can be performed with a variety of different velocities, allowing to realize an efficient and fast approach between the SIL and the record carrier.

### BRIEF DESCRIPTION OF THE DRAWINGS

In the following preferred embodiments of the invention will be described by making reference to the drawings in which:

FIG. 1 schematically shows an optical scanning device in accordance with an embodiment of the present invention,

FIG. 2 schematically shows a diagram of elements in a head for near field optical scanning,

FIG. 3 illustrates two diagrams showing gap distance and velocity of the lens movement versus time,

FIG. 4 schematically illustrates origin of an aperture pupil image,

FIG. 5 illustrates six aperture pupil images for varying gap sizes,

FIG. 6 illustrates a simulated interference pattern in an aperture pupil image,

FIG. 7 shows a diagram of central aperture intensity versus decreasing gap distance,

FIG. 8 illustrates a flow chart of performing an approach procedure method making use of image processing,

FIG. 9 illustrates a flow chart for performing an approach procedure making use of intensity variations.

### DESCRIPTION OF THE PREFERRED EMBODIMENTS

An optical recording system using a near field optical head, which comprises an aspherical lens and a Solid Immersion Lens (SIL), has been proposed as a technology to readout 50 Gbyte or more on a 12 cm optical disc. In this system, it is essential to maintain an air gap between the SIL bottom surface and the disc constantly in a near field position where the evanescent wave is detectable. Thereto an air gap servo system is required.

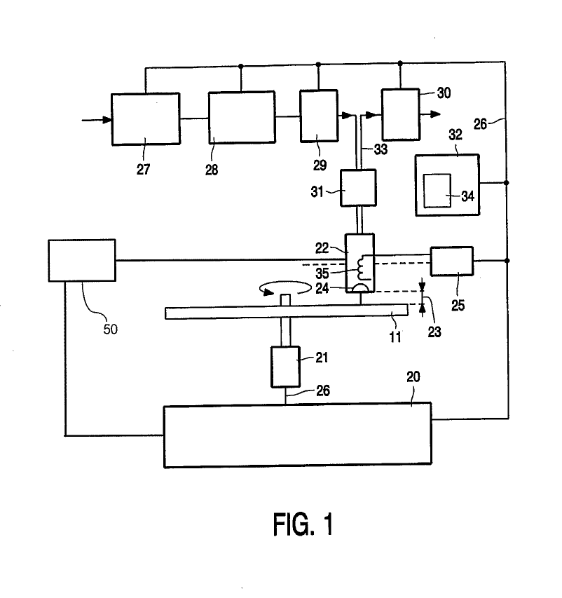

FIG. 1 shows an optical recording device having an air gap servo. The device is for optically reading and/or recording data on a record carrier 11 via a near field optical system. The illustrated near field optical system is similar to those that are known as such e.g. from K. Saito, et al, “Readout Method for Read Only Memory Signal and Air Gap Control Signal in a Near Field Optical Disc System,” Jpn. J. Appl. Phys. Vol. 41 (2002), pp. 1898-1902. The disc-shaped record carrier 11 has a track arranged as a spiral or annular pattern of turns constituting substantially parallel tracks on an information layer. The track on a recordable type of record carrier may be indicated by a pre-embossed track structure provided during manufacture of the blank record carrier, for example a pregroove. A track structure may also be formed by regularly spread marks which periodically cause servo signals to occur. Recorded information is represented on the information layer by optically detectable marks recorded along the track. The marks are constituted by variations of a physical parameter and thereby have different optical properties than their surroundings, e.g. variations in reflection obtained when recording in materials such as dye, alloy or phase change material, or variations in direction of polarization obtained when recording in magneto-optical material. The record carrier may be intended to carry real-time information, for example video or audio information, or other information, such as computer data.

The near field optical scanning device further has an image processing unit 50 that is coupled to the head 22. The image processing module 50 is adapted to identify a central aperture region, i.e. a centrally located bright section of an aperture pupil image acquired by the head 22 and to generate a control signal depending on the diameter of this centrally located bright section. The image processing module 50 might be adapted to process output signals generated by a detector of the head 22. The image processing module 50 identifies the size and/or diameter of a centrally located circularly shaped bright section in the obtained aperture pupil image and generates a corresponding control signal being indicative of the transverse size of this bright section. Since the transverse size of this bright section in the aperture pupil image is directly correlated to the gap size between the lens 24 and the record carrier 11, the corresponding control signal can be exploited by the control unit 20 in order to bring the head 22 and lens 24 to the near field distance or near field position 23 in a fast and efficient way.

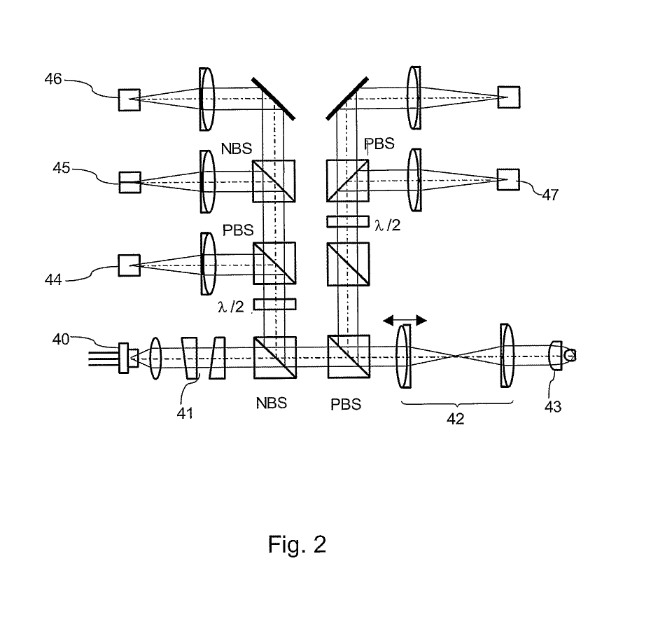

The device is provided with means for scanning a track on the record carrier 11, which means include a drive unit 21 for rotating the record carrier 11, a head 22, a servo unit 25 for positioning the head 22 on the track and a control unit 20. The head 22 comprises an optical system of a known type for generating a radiation beam guided through optical elements focused to a radiation spot on a track of the information layer of the record carrier. The radiation beam is generated by a radiation source, e.g. a laser diode. The head comprises a lens 24, and a lens actuator 35 coupled to an air gap servo controller in the servo unit 25 for positioning the lens at a near field distance 23 from the surface of the record carrier 11. A detailed example of optical elements in the head is shown in FIG. 2. According to the invention the air gap servo includes a air-gap controller 32, which may include a reference generator 34 for a hand-over mode. The air gap controller has an approach mode for bringing the lens from a remote distance to the near field distance by making use of the control signal generated by means of the image processing module 50. Finally, when the lens is within the near field distance, the air gap controller switches to a closed loop mode. Switching from the open loop approach mode to the closed loop mode may be performed in a hand-over mode, during which reference trajectories for position, and/or speed and acceleration of the lens are generated by the reference generator 34. Embodiments of the air gap servo system and elements are described and shown below in detail.

The head further comprises (not shown) a focusing actuator for focusing the beam to create the radiation spot on the track by moving the focus of the radiation beam along the optical axis of said beam, and a tracking actuator for fine positioning of the spot in a radial direction on the center of the track. The tracking actuator may comprise coils and permanent magnets for radially moving an optical element or may alternatively be arranged for changing the angle of a reflecting element. For reading the radiation reflected by the information layer is detected by a detector of a usual type, e.g. a four-quadrant diode, in the head 22 for generating detector signals, including a main scanning signal 33 and sub-detector signals for tracking and focusing. A front-end unit 31 is coupled to the head 22 for receiving the detector signals based on radiation reflected from the track. The main scanning signal 33 is processed by read processing unit 30 of a usual type including a demodulator, deformatter and output unit to retrieve the information.

The control unit 20 controls the recording and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and function as described below. The control unit 20 may also be implemented as a state machine in logic circuits.

The device may be provided with recording and reading means for recording and reading information on record carriers of a writable or re-writable type. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the power of the beam of radiation is controlled by modulator 29 to create optically detectable marks in the recording layer.

In an embodiment the input unit 27 comprises compression means for input signals such as analog audio and/or video, or digital uncompressed audio/videa. Suitable compression means are described for video in the MPEG standards, MPEG-1 is defined in ISO/IEC 11172 and MPEG-2 is defined in ISO/IEC 13818. The input signal may alternatively be already encoded according to such standards.

FIG. 2 shows a schematic diagram of elements in a head for near field optical recording. The schematic diagram provides an example of a near-field optical player setup used for readout experiments. In the experimental player a conventional DVD actuator is used for air gap control and tracking in which a special near field lens is mounted having a numerical aperture NA=1.9. In the figures PBS=Polarizing beam-splitter; NBS=Non-polarizing beam-splitter; and λ/2=half-wave plate. The set-up consists of a main branch comprising a blue-violet laser 40 and collimator lens, beam shaping optics 41, two beam-splitters and a telescope 42 for focus adjustment of the NA=1.9 lens 43. The left side branch in the figure contains a photodiode 44 for detection of the RF central aperture signal that contains the data information and is polarized parallel to the main beam. In the same branch a split detector 45 is positioned to generate a push-pull tracking error signal. Moreover, for the experimental set-up only, a CCD camera 46 is included to observe the irradiance pattern at the exit pupil, hence to acquire the aperture pupil image. A half-wave plate λ/2 is used to control the amount of light that the PBS splits and directs towards the RF detector and the push pull detector, respectively.

The second branch on the right side of the figure is used to generate the error signal for air gap control. In near field optical disk systems, the SIL lens 43 needs to be positioned within the evanescent decay distance from the disk. In the set-up the SIL to disk distance is typically 25 nm. To allow air gap control with a mechanical actuator at such small distances, a suitable error signal is required. As described in a linear signal that is suitable as a gap error signal (GES) can be obtained from the reflected light with a polarization state perpendicular to that of the main beam that is focused on the disk. A significant fraction of the light becomes elliptically polarized after reflection at the SIL-air-disk interfaces: this effect creates the well-known Maltese cross when the reflected light is observed through a polarizer. By integrating all the light of this Maltese cross using polarizing optics and a single photodetector 47, a so-called “RF ⊥ pol” signal is obtained, and a gap error signal GES is generated from the “RF ⊥ pol” signal.

The output of CCD array detector 46 is coupled to the image processing module 50 as shown in FIG. 1. Based on the output of detector 46, the image processing module 50 generates the required control signal and provides said control signal to the control unit 20 for performing the fast, efficient, accurate and reliable approach between lens 24 and record carrier 11.

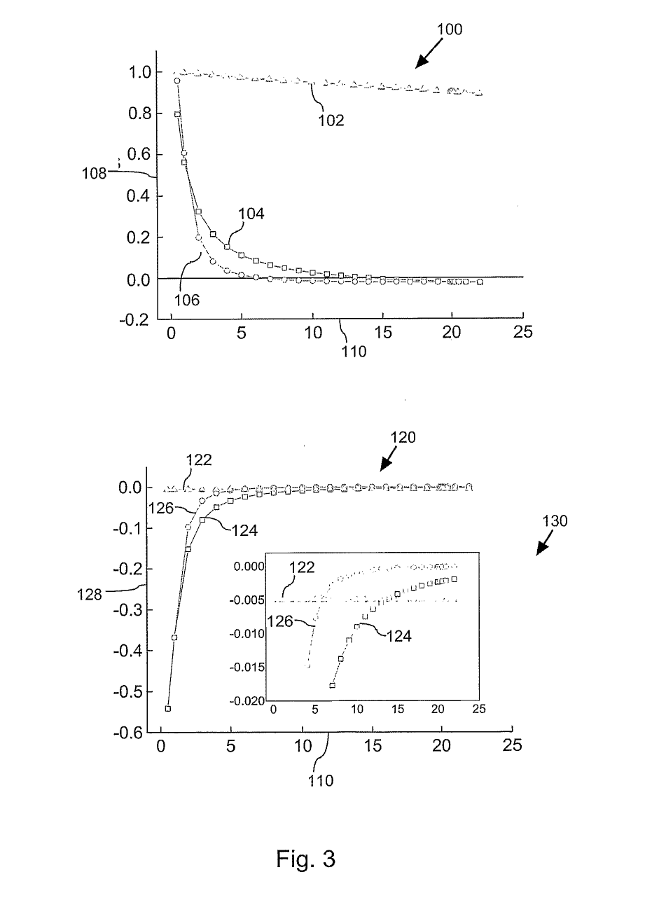

FIG. 3 shows two diagrams 100, 120 illustrating gap distance and velocity of lens movement versus time. Diagram 100 illustrates gap distance 108 in units of 100 micrometers versus time 110, that is given in arbitrary units. The diagram 100 shows three curves 102, 104, 106. Curve 102 corresponds to a movement of the head and/or its objective system including the SIL with a constant slow velocity. Such a constant and slow velocity is required when a gap size indicating control signal is only available for very small gap distances that are in the order of magnitude of the near field position, i.e. that are in a range of e.g. 50 nm to 100 nm. Such a constantly slow approach of the lens 24 towards the record carrier 11 reflects limitations of the prior art where gap size information for gap sizes in the range of micrometers is generally not available.

Curves 104, 106 represent a much faster approach, where the gap distance 108 reaches a desired value in the range of nanometers within relatively short time intervals. Curve 104 corresponds to an exponential decrease of the gap distance 108 and curve 106 even corresponds to an exponential decrease with a squared time parameter. In particular, curve 104 corresponds to A-B exp (−C/time) and curve 106 corresponds to a similar mathematical expression A′-B′ exp (−C′/time²) with a squared time parameter, A,B,C and A′,B′,C′ refer to constant parameters. As can be seen in the diagram 100, curve 104 reaches a required near field distance after fourteen arbitrary time units and curve 106 even reaches the predefined near field position after seven arbitrary time units.

The control unit 20 is adapted to calculate or to store such exponential decreasing curves 104, 106 and to drive the servo unit 25 and hence the actuator 35 in a way that is given by the curves 104 and 106. By decreasing the gap size in a way given by diagrams 100 and 120, an approach procedure can be optimized starting with a large velocity for large gap sizes and successively reducing the approach velocity as the gap size reduces.

In this way the approach or bring-in procedure of the SIL can be performed in a fast and efficient way while simultaneously guaranteeing that collisions between record carrier and SIL cannot occur. As soon as the gap distance reduces from 100 micrometers to e.g. 10 or 20 micrometers, the control signal indicating the gap size can be determined with a higher precision thus allowing to dynamically adapt the velocity of the approach procedure. The substantially slower movement for very small gap sizes effectively allows to generate successive control signals for the control unit 20.

Diagram 120 illustrates a corresponding velocity versus time for the gap distance diagram 100. Again the triangle shaped curve 122 refers to a constant and small velocity of the head 22. Curve 126 corresponds to curve 106 of diagram 100 and curve 124 of diagram 120 corresponds to a movement given by curve 104 of diagram 100. Both curves 124 and 126 illustrate a decreasing velocity 128 versus time 110. The velocity is given as negative velocity in arbitrary units as the movement of the head 22 minimizes the gap size. Diagram 130 illustrates an enlarged view of the intersection points of the three curves 122, 124 and 126. It can clearly be seen that curve 126 reaches a zero velocity first, followed by curve 124.

The illustrated temporal distance and velocity profiles are only examples of how to perform an approach procedure between lens 24 and record carrier 11. Other conceivable velocity profiles may feature a step profile or other sinusoidal profiles or even linearly decreasing velocity or distance profiles. A velocity or distance versus time can be given as a predefined function or may be dynamically adapted during a movement of the head 22.

In principle, a movement of the lens 24 by making use of any of the above described temporal velocity or distance profiles can also be realized by asserting that the remote position of the lens 24 is given with an accuracy in the range of e.g. nanometers. In this case the initial gap size and the remote position are accurately known and a distance measurement is generally not required. This particularly involves mounting means for fixing the record carrier 11 in the near field optical scanning device with a desired high precision.

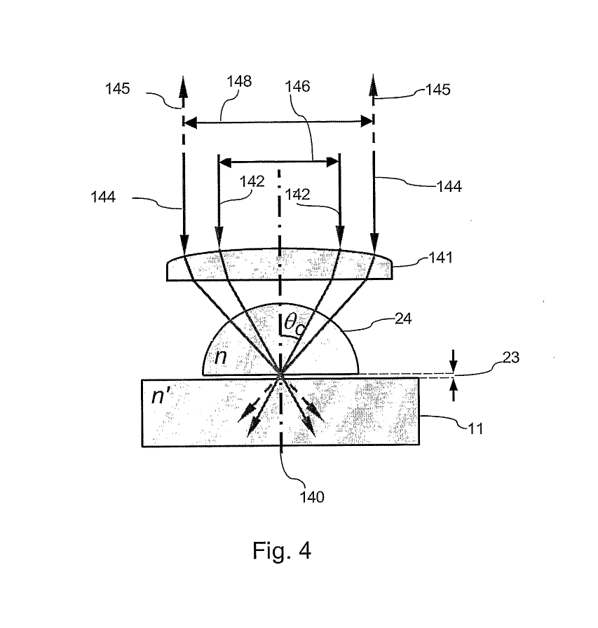

FIG. 4 schematically illustrates the origin of a aperture pupil image that can be recorded by the detector 46. FIG. 4 shows a cross sectional view of the lens system featuring at least a focusing lens 141 and the Solid Immersion Lens 24. The Solid Immersion Lens 24 may be positioned in a near field distance 23 with respect to the record carrier 11. Optical rays 144 propagating towards the record carrier 11 are focused by means of the focusing lens 141 near the exit surface of the SIL 24. Rays 144 propagate inside SIL 24 at an angle exceeding the angle of total internal reflection θ_{c} that is governed by the refractive index n of the SIL.

Hence, when the gap 23 is significantly larger than approximately 50 nm, i.e. no evanescent coupling occurs, rays 144 are subject to total internal reflection at the exit surface of the SIL 24 due to their large propagation angle with respect to the optical axis 140. Rays 144 that are subject to internal total reflection inside the lens 24 return to the objective system as rays 145 the same angle of incidence as rays 144. Since rays 144 are subject to total internal reflection near the focal point of the focusing lens 141, the reflected rays 145 re-enter the objective system in the same way as rays 144 propagate towards the record carrier 11. The large propagation angle and the total internal reflection are thus the reason for the formation of a bright outer ring in the aperture pupil image. The width 148 of this outer ring is preferably given by the aperture of the focusing lens 141 and the concrete arrangement of involved optical components.

Only when the gap size is smaller than approximately 50 nm, internal reflection is frustrated and rays 144 can propagate to the record carrier 11. Consequently, the bright ring in the aperture pupil image will disappear.

Propagation of rays 142 that propagate through the SIL 24 at angles smaller than the critical angle θ_{c} for total internal reflection are transmitted through the SIL 24. These rays 142 propagate towards the surface of the record carrier 11 and may become subject to reflection at the surface of the record carrier 11. Depending on the distance between record carrier 11 and SIL 24, the optical field formed by rays 142 may feature a certain diameter being much larger than the focal spot. In this case radiation that has been transmitted through the SIL towards the record carrier 11 is reflected by the record carrier 11 over a surface that is much larger than the circumference of the focal spot. Hence, only a very small fraction of reflected light may re-enter the objective system at a small angle with respect to the optical axis 140.

In principle, the distance between the focal spot and the reflective surface of the record carrier 11 determines a maximum angle at which reflected light may re-enter the cone that is given by rays 142. Rays featuring a larger angle than this maximum angle may not be properly projected onto the detector array and may not re-enter the objective system. The maximum angle of incidence increases with decreasing distance between focal spot and the light reflecting surface of the record layer 11. This increasing maximum angle reflects in an increase of the diameter of the bright circular shaped section in the center of the aperture pupil image. It is therefore a direct indication for the distance between SIL and record carrier surface.

It is further to be noted that the present invention is applicable to any tracks of the record carrier irrespective whether they contain grooves representing information or whether they feature a non-structured surface. Since acquisition of the aperture pupil image is performed in the far field, near field coupling that might be sensitive to surface modulations of the record carrier, is almost completely negligible. However, the inventive method is also applicable to unstructured surface areas of the record carrier 11.

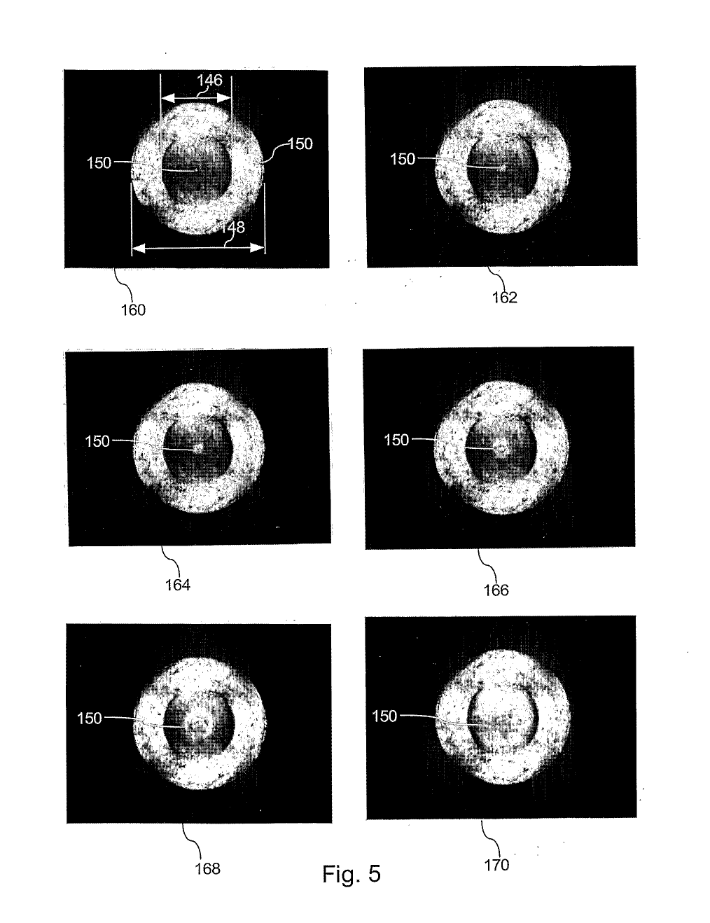

FIG. 5 illustrates a sequence of six aperture pupil images 160, 162, 164, 166, 168 and 170. The bright ring featuring a width 148 is due to total internal reflection at the bottom surface of the SIL 24 and the inner dark region featuring a diameter 146 corresponds to light that has been transmitted through the SIL and that is therefore not present in the illustrated reflection image 160. In the center of the structure illustrated by the image 160 a bright spot 150 can be observed. In the sequence of images 160, . . . , 170 this bright spot 150 evolves to a circular shaped section whose diameter remarkably increases for each of the successive images, until in image 170 it becomes almost as large as the inner radius of the surrounding bright ring 152. The images 160, . . . , 170 correspond to gap sizes of 100 micrometers, 20 micrometers, 15 micrometers, 10 micrometers, 5 micrometers and 2 micrometers. As can be seen from image 162 for a gap size of 20 micrometers already a clear bright central section is detectable allowing to generate a corresponding control signal.

Image processing means may be adapted to compare the brightness and/or intensity of the central region with surrounding regions or with a stored reference value corresponding to an absent record carrier 11. The detector as well as the image processing means might be implemented on a two dimensional detection and image processing scheme or a corresponding one dimensional detection and image processing mechanism. For example the detector 46 can be implemented as a one dimensional line of CCD pixels. In this case it must be guaranteed that the aperture pupil image 160, . . . , 170 is centrally projected onto the detector line array. Generally, the size of the bright central section of the aperture pupil images can be determined by the number of detector pixels detecting an intensity that is above a reference value. Magnitude of such a reference value may be obtained in the absence of the record carrier 11. Alternatively, the reference value may also indicate the brightness of the bright central section 150 that may be obtained as e.g. average intensity of the surrounding bright ring 152.

Furthermore, images 166 and 168 feature a spatial structure of concentric bright and dark rings that are due to interference between incident and reflected light. These concentric rings are also indicative of the gap size between SIL 24 and record carrier 11. The number of rings as well as their position can further be exploited in order to determine the size of the gap and the distance between SIL 24 and record carrier surface. These additional distance indicators that are due to interference are already visible at a distance of 10 micrometers as illustrated by image 166. In this image a dark ring within the bright central circular shaped section is clearly visible.

In image 168 these concentric rings are not as clearly visible as in image 166. Anyhow, image 168 indicates their existence. The contrast of the rings is typically spoiled by vibrations of the entire optical system as well as by air fluctuations. Making use of a shorter exposure time for acquiring the images 160, . . . , 170 generally allows to visualize the concentric rings with a better contrast.

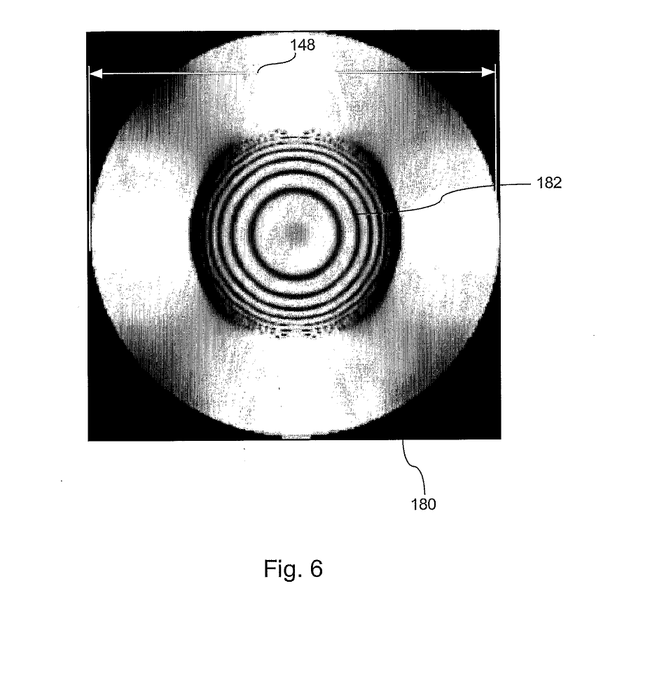

FIG. 6 illustrates a simulated aperture pupil image 180 that corresponds to image 170 of FIG. 5. In the simulated image 180, the interference fringes 182 are clearly visible. Depending on the concrete optical implementation of the near field optical scanning device, the interference fringes 182 typically become visible for gap sizes in the range of several micrometers. In application scenarios where the head 22 or lens 24 are moved with a predefined velocity towards the record carrier 11 and where a control signal is not yet available, appearance of interference fringes in the aperture pupil image 180 may serve as an indicator that some predefined gap size has been reached.

Detection and/or analysis of interference fringes of an aperture pupil image can be implemented by making use of a photo detector being adapted to detect a small area of the aperture pupil image 180. During an approach procedure, the interference fringes 182 are subject to movement and therefore allow to make use of a photo detector only detecting a small fraction of the transverse plane of the aperture pupil image 180. The recorded intensity may substantially vary depending on whether the detector detects a bright or a dark fringe of the interference pattern 182. The beginning of such an oscillation may serve as a trigger for successively reducing velocity of an approach movement. Moreover, by counting these fluctuations or oscillations, precise information of an ongoing movement can be obtained and further be processed in order to adapt the velocity of the lens 24.

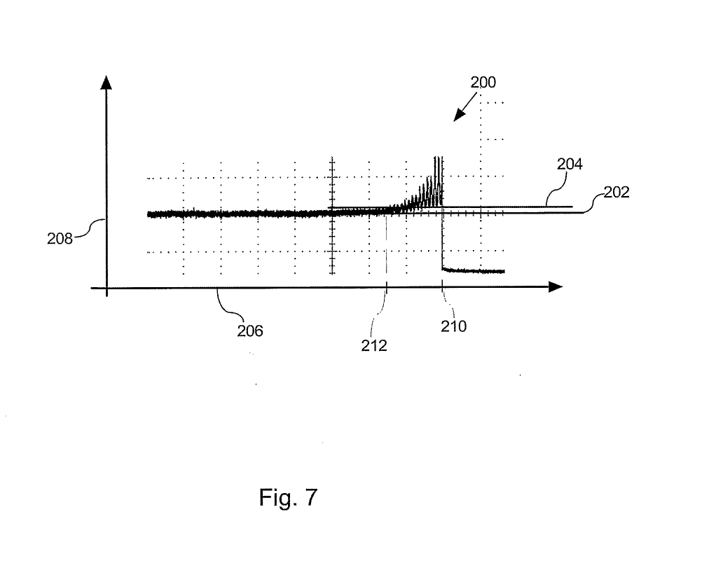

FIG. 7 shows a diagram 200 illustrating intensity of the detector output 208 versus decreasing gap distance 206. At gap distance 212 the signal starts to oscillate with increasing amplitude for decreasing gap sizes. In the experiment, the distance 212 corresponds to 3 μm.

Increasing amplitude of the detected signal gives an indication of increasing overall intensity of the central circular shaped section 150 of the aperture pupil images and the oscillations refer to the moving interference fringes. In typical experimental implementations these fluctuations may evolve for gap sizes around 10 micrometers and below. Additionally, successive maxima or minima of the oscillating signal indicate a movement of λ/2. Making use of radiation around 400 nm, the distance between two maxima or minima corresponds to a movement of 200 nm.

For detecting the beginning of the oscillation 212 of the intensity signal it is convenient to make use of two thresholds 202, 204. Threshold 202 corresponds to the intensity signal that is obtained for rather large gap distances, hence, distances that refer to the left hand side of the illustrated graph. Threshold 204 might be chosen such that it is just above the noise level of the large distance intensity signal. The intensity signal may only exceed threshold 204 in case of non-negligible generation of interference fringes in the aperture pupil image. The thresholds 202, 204 can be effectively defined by performing a calibration procedure for a given arrangement of optical components of the near field optical scanning device.

At gap distance 210 the intensity signal remarkably drops due to evanescent coupling that starts to take place between SIL and the surface of the record carrier 11. Gap size 210 therefore corresponds to the near field position of the lens 24, that corresponds to the target position of the approach procedure. Bringing the lens 24 close to this target position or near field position a handover to the closed loop control mechanism using the GES may be performed.

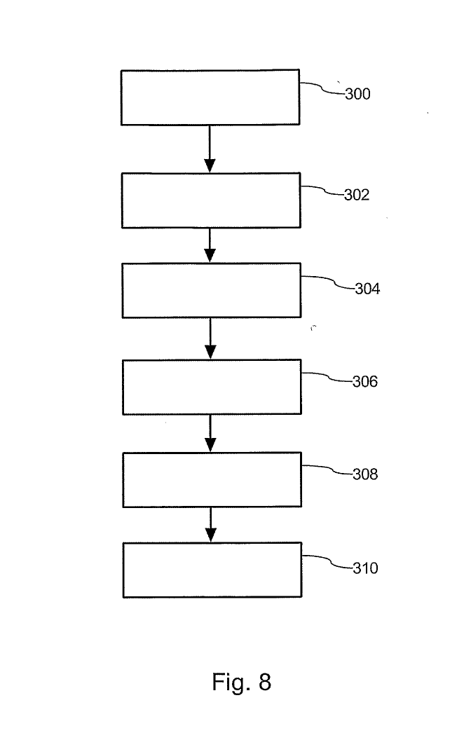

FIG. 8 is illustrative of a flowchart for performing the inventive approach procedure. In a first step 300 an aperture pupil image is acquired by means of the detector and provided to the image processing module 50. In the successive step 302, the image processing module 50 identifies a central bright spot or centrally located circular shaped section of the acquired aperture pupil image and determines its diameter or its general size. Thereafter, in step 304 depending on the determined size or diameter a control signal is generated. The control signal is indicative of the gap size between lens 24 and surface of the record carrier 11. After having generated the control signal in step 304, the control signal is provided to the control unit 20 in step 306, where the control signal is further processed for realizing an efficient and fast approach of the lens 24 with respect to the record carrier 11.

In the following step 308, based on the received control signal the control unit 20 may select a predefined velocity profile or may calculate a velocity profile or may modify a predefined and stored velocity profile for the movement of the head 22. After a velocity profile has been generated by means of the control unit 20, corresponding control signals are submitted to the servo unit 25 that is adapted to perform a corresponding movement of the head 22 in step 310.

Depending on the accuracy of the control signal generated in step 304, the entire procedure may be repeatedly performed even during a moving of the head 22. This allows to successively generate a whole set of control signals that in turn allow to modify an ongoing movement and to provide a maximum of accuracy during the approach procedure. Making use of image processing of the aperture pupil image, the control signal can be generated with increasing accuracy for decreasing gap sizes. This property of the near field optical scanning device effectively allows to perform the approach procedure in an adaptive and accurate way.

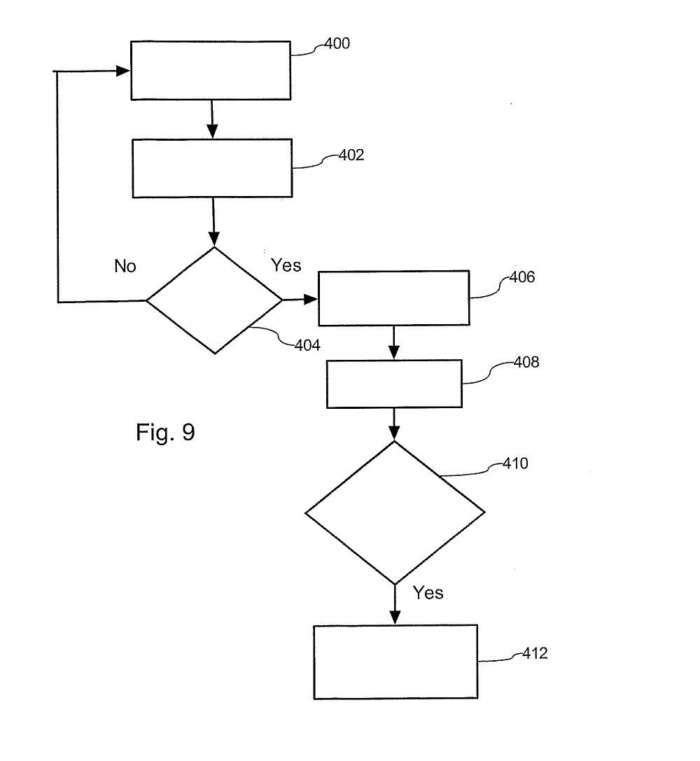

FIG. 9 illustrates another flowchart for performing an alternative method of bringing the lens into a near field position with respect to the surface of the record carrier 11. This method is preferably applicable when no control signal can be generated for the initial remote position of the lens. Advantageously, this method makes only use of monitoring the intensity of the aperture pupil image and does not require a spatially resolved image acquisition of the aperture pupil image. In a first step 400 the lens 24 and/or the head 22 are moved with an initial velocity that may correspond to a maximum velocity of the actuator 35. During this movement the intensity of the aperture pupil image is monitored in step 402. Monitoring of this intensity may refer to monitoring the intensity of the entire image or of a fraction of the image, e.g. the central part of the image. In the following step 404, the monitored intensity is compared with a predefined threshold value that may correspond to the threshold value 202 of FIG. 7.

When the intensity determined in step 402 substantially exceeds the threshold given by 202 the method continues with step 406 and decreases the velocity of the lens movement. Otherwise, if the threshold value of the intensity is not exceeded in step 404, the method returns to step 400. In this case steps 400, 402, 404 are repeatedly applied as long as the intensity does not exceed the given threshold value T₁.

Alternative to a comparison with a given threshold value T₁, step 404 may also be implemented by means of an oscillation detection scheme. In this case, in step 404 it is checked whether a monitored intensity is subject to an oscillation. Only in case that the monitored intensity starts to oscillate, the method may continue with step 406 where the lens velocity is reduced.

After detection of starting oscillations of the intensity signal and after reducing the velocity of the movement in step 406, in step 408 the oscillations are counted with decreasing gap size. These counts may be exploited in order to further reduce the velocity of the lens and/or to generally control the actual position of the SIL 24 with respect to the record carrier surface. In a successive step 410, it is checked whether a maximum count has been reached that corresponds to the desired near field gap size. Hence, the maximum count number may correspond to gap sizes in the range of 50 to 150 nm. In response to detection of the maximum count in step 410, in a final step 412 a handover to the closed loop control mechanism is performed making use of an air gap control signal that can be derived due to a change in the polarization state between reflected and incident light, hence an error signal that is accessible when SIL 24 and record carrier 11 feature a near field distance.

The present invention is by no means restricted to a specified near field optical scanning device as described in the embodiments of the present invention. The invention is generally suitable for other record carrier and head systems that need a small air gap between any lens and record carrier surface, such as rectangular optical cards, magneto optical discs or any other type of information storage system, or a near field scanning microscope system. The expression near field optical scanning device includes any of these above mentioned systems. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. A near field optical scanning device for scanning a record carrier (11), the device comprising:
a head (22) having a lens (24) being adapted to be positioned in a near field position (23) relative to the surface of the record carrier,
a detector (46) having a spatial resolution for detecting radiation entering the head,
an image processing module (50) for analyzing the detector output and being adapted to generate a control signal being indicative of the distance between the lens and the record carrier,
a control module (20) for controlling a gap size of a gap between the lens and the surface of the record carrier, the control module being operable in an approach mode for moving the lens from a remote position to the near field position, the approach mode making use of the control signal.

2. The device according to claim 1, wherein the control module (20) is operable to move the lens (24) from the remote position to the near field position (23) with a varying velocity, the velocity depending on the control signal.

3. The device according to claim 1, wherein the control module (20) is further operable to move the lens (24) by making use of a decreasing velocity profile (124, 126) starting with a maximum velocity.

4. The device according to claim 1, wherein an at least second control signal is generable during a movement of the lens (24) and wherein the control module (20) is further operable to process the at least second control signal during the movement.

5. The device according to claim 1, wherein the image processing module (50) is adapted to determine the size of a central section (150) of the radiation in a transverse plane of the radiation, the size of the central section being used by the image processing module for generating the control signal.

6. The device according to claim 1, wherein the image processing module (50) is adapted to analyze the spatial structure (182) of a central section of the radiation (150) in a transverse plane of the radiation, the spatial structure of the central section being used by the image processing module for generating the control signal.

7. The device according to claim 1, wherein the image processing module (50) is adapted to monitor the intensity of a central section of the radiation in a transverse plane of the radiation and to generate the control signal in response of the intensity exceeding a predefined threshold (204).

8. The device according to claim 5, wherein the central section of the radiation (150) in the transverse plane of the radiation corresponds to radiation re-entering the lens (24) after being reflected by the record carrier (11) and being transmitted through the lens towards the record carrier.

9. The device according to claim 1, wherein the control module (20) is adapted to switch into a gap control mode if the lens has been moved to the near field position.

10. A method of bringing a lens (24) of a head (22) of a near field optical scanning device from a remote position to a near field position (23) relative to the surface of a record carrier (11), the method comprising:
detecting radiation entering the head by making use of a detector (46) having a spatial resolution,
analyzing the detector output by making use of an image processing module (50) for generating a control signal being indicative of the distance between the lens and the record carrier,
moving the lens from the remote position to the near field position by making use of the control signal.

11. The method according to claim 10, further comprising moving the lens (24) by means of a decreasing velocity profile (124, 126) starting with a maximum velocity and wherein the velocity profile is selected or created with respect to the control signal.

12. The method according to claim 10, further comprising:
moving the lens (24) with a predefined velocity towards the record carrier (11) prior to generation of the control signal,
monitoring the size of a central section (150) of the radiation in a transverse plane of the radiation by means of the detector (46) and the image processing module (50) during moving of the lens with the predefined velocity,
generating the control signal by making use of the size of the central section.

13. A method of bringing a lens (24) of a head (22) of a near field optical scanning device from a remote position to a near field position (23) relative to the surface of a record carrier (11), the method comprising:
moving the lens from the remote position towards the record carrier,
monitoring the intensity of a radiation entering the head during moving of the lens by making use of a detector (46),
generating a control signal being indicative of a distance between the lens and the surface of the record carrier, the control signal being generated in response of detecting at least one oscillation of the intensity with respect to the movement of the lens,
moving the lens to the near field position by making use of the control signal.

14. The method according to claim 13, wherein the at least one oscillation of the intensity indicates a distance between the surface of the record carrier (11) and the lens (24) that is sufficiently larger than the distance for which evanescent coupling between the lens and the record carrier effectively occurs.
